(19) United States
(12) Patent Application Publication
(10) Pub. No.: US 2026/0221845 A1
(43) Pub. Date: Jul. 30, 2026

(54) SYSTEMS FOR THERMAL MANAGEMENT OF A VEHICLE

(71) Applicant: DANA TM4 INC., Boucherville (CA)

(72) Inventors: Steven VANHEE, Hooglede (BE); Jaywant S. PAWAR, Pune (IN); Sandesh Rathnavarma HEGDE, Laval (CA); Alexandre PARE, Saint-Amable (CA)

(21) Appl. No.: 19/323,950

(22) Filed: Sep. 9, 2025

Related U.S. Application Data
(60) Provisional application No. 63/751,108, filed on Jan. 29, 2025.

(51) Int. Cl. H02K 9/193; H02K 5/16; H02K 7/00; B60K 1/00

(52) U.S. Cl. CPC H02K 9/193; H02K 5/161; H02K 7/003; B60K 1/00; B60K 2001/006; H02K 2205/00

(57) ABSTRACT

Systems are provided for a cooling system for an electric vehicle. In one example, a system includes a shaft assembly comprising a shaft outlet flange, a shaft inlet flange, and an insert arranged in an interior volume shaped by the shaft outlet flange and the shaft inlet flange, wherein the shaft inlet flange comprises an interior volume with interior surfaces in face-sharing contact with a lance and radially aligned with a bearing and an air vent arranged in the shaft inlet flange at a position upstream of the bearing and the interior volume relative to a direction of lubricant flow.

### CROSS REFERENCE TO RELATED APPLICATIONS

The present application claims priority to U.S. Provisional Application No. 63/751,108, entitled “SYSTEMS FOR THERMAL MANAGEMENT OF A VEHICLE”, and filed on January 29, 2025. The entire contents of the above-listed application are hereby incorporated by reference for all purposes.

### TECHNICAL FIELD

The present description relates generally to a thermal management system of a motor shaft of a vehicle.

### BACKGROUND AND SUMMARY

Vehicles may be equipped with electrical energy storage devices to decrease vehicular contributions to global warming. An electric motor may be configured to operate via electrical energy provided by the electrical energy storage device, wherein the electric motor may drive one or more wheels of the vehicle. Like an engine, the electric motor may demand cooling during certain operating conditions to control a temperature of the electric motor and its components.

An efficiency of the electric motor may be at least partially based on an efficiency of the cooling provided to the electric motor and its components. Stator windings may represent one component in which previous examples of cooling may be insufficient. Other components which may demand enhancements in cooling may include the rotor, the motor shaft, and bearings of the motor.

In one example, the issues described above may be addressed by a system including a shaft assembly comprising a shaft outlet flange, a shaft inlet flange, and an insert arranged in an interior volume shaped by the shaft outlet flange and the shaft inlet flange, wherein the shaft inlet flange comprises an interior volume with interior surfaces in face-sharing contact with a lance, the shaft inlet flange is and radially supported by a bearing. The system further includes an air vent arranged in the shaft inlet flange at a position upstream of the bearing and the interior volume relative to a direction of lubricant flow.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

The above, as well as other advantages of the present disclosure, will become readily apparent to those skilled in the art from the following detailed description when considered in light of the accompanying drawings in which:

FIG. 1 is a schematic depiction of an example vehicle powertrain, according to an embodiment of the present disclosure;

FIG. 2 is a schematic depiction of a cross-section of a shaft, according to an embodiment of the present disclosure;

FIG. 3 is a depiction of a first side of an electric motor housing, according to an embodiment of the present disclosure;

FIG. 4 is a depiction of a second side of the electric motor housing, according to an embodiment of the present disclosure;

FIG. 5 is a depiction of a cross-sectional view of the motor shaft including a direction of lubricant flow, according to an embodiment of the present disclosure;

FIG. 6A is a first view of the shaft insert, according to an embodiment of the present disclosure;

FIG. 6B is a second view of the shaft insert, according to an embodiment of the present disclosure;

FIG. 6C is a cross-sectional view of the shaft insert, according to an embodiment of the present disclosure;

FIG. 7A is a perspective view of the shaft inlet flange, according to an embodiment of the present disclosure; and

FIG. 7B is a cross-sectional view of the shaft inlet flange, according to an embodiment of the present disclosure.

### DETAILED DESCRIPTION

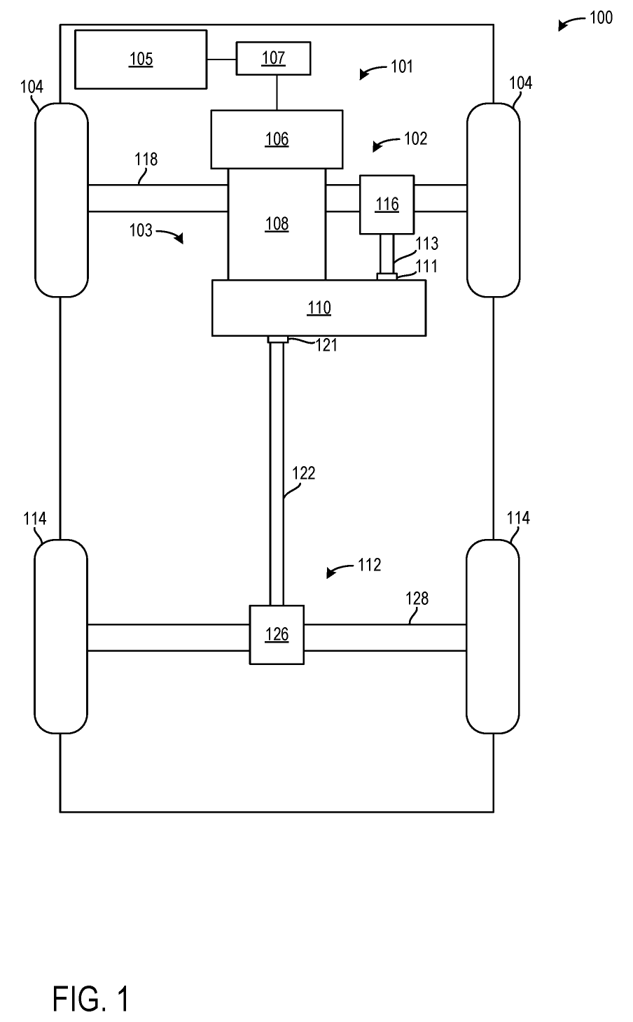

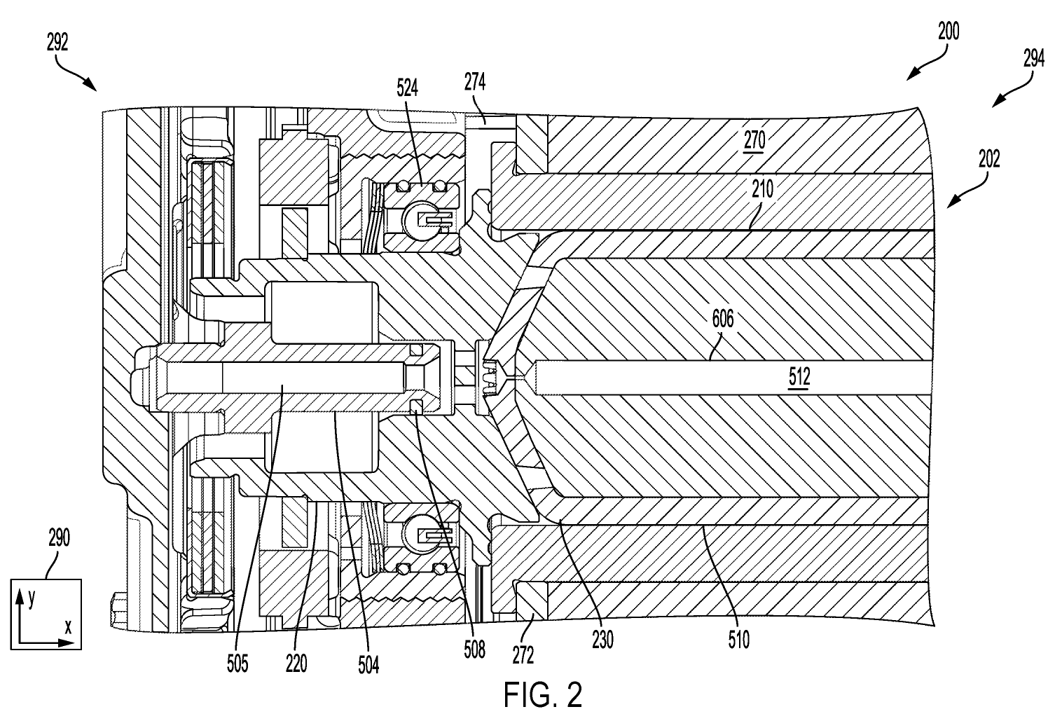

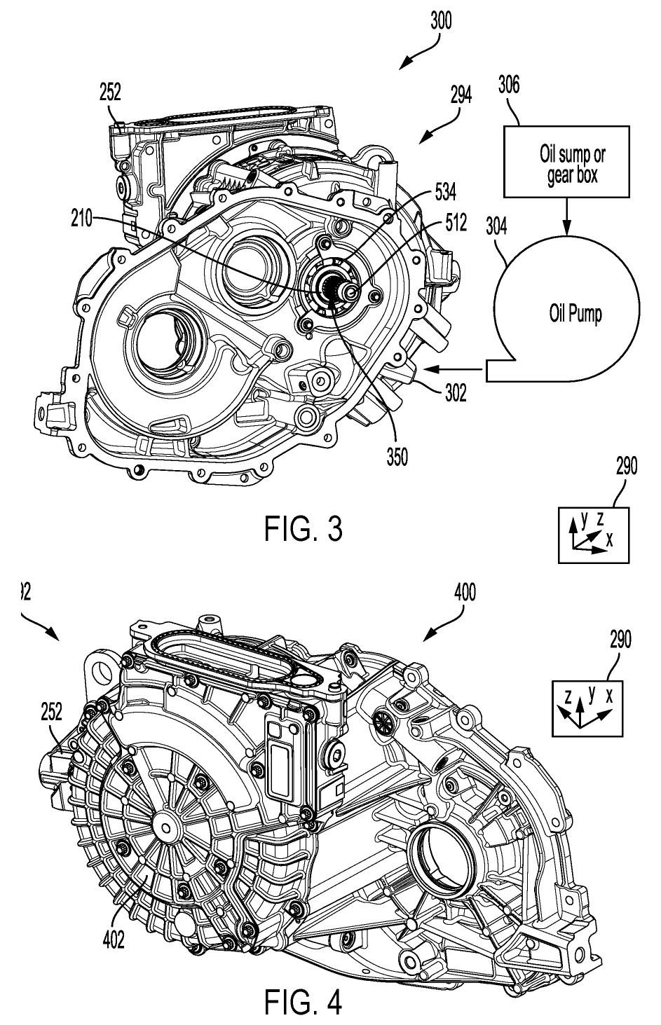

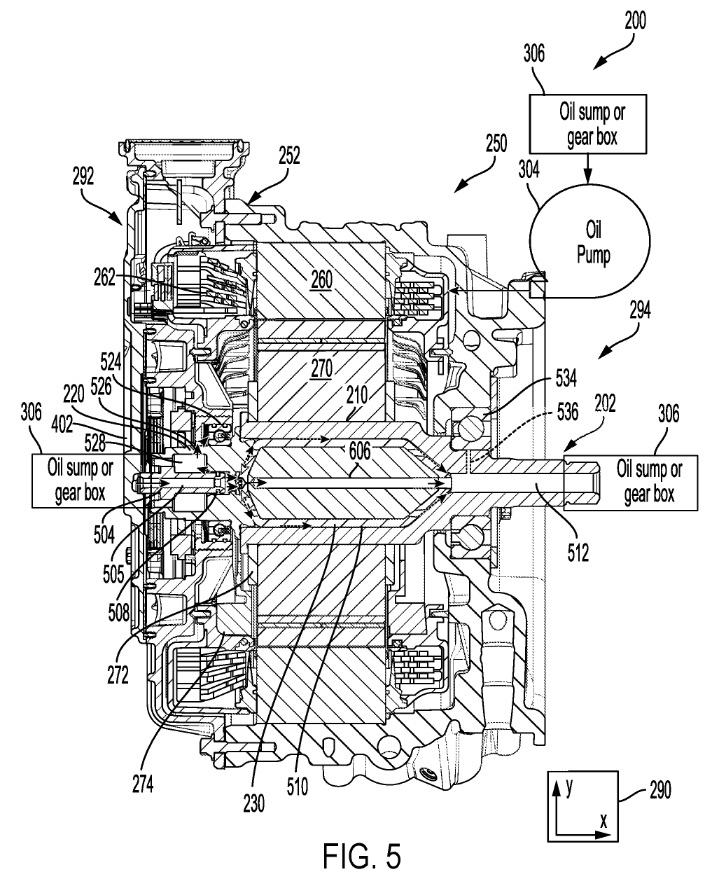

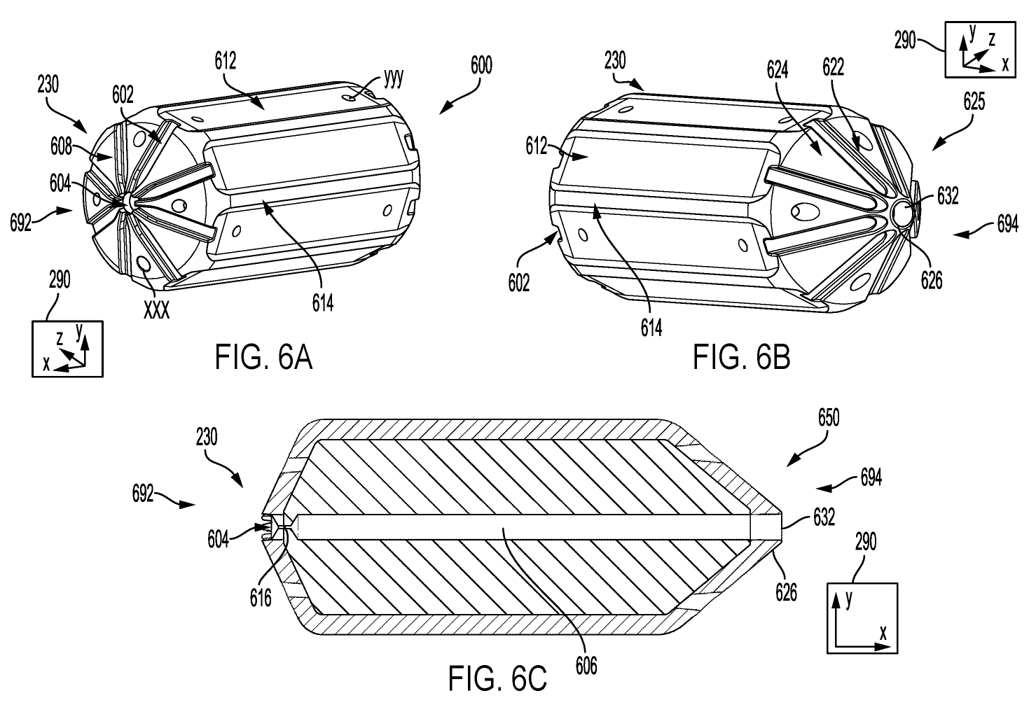

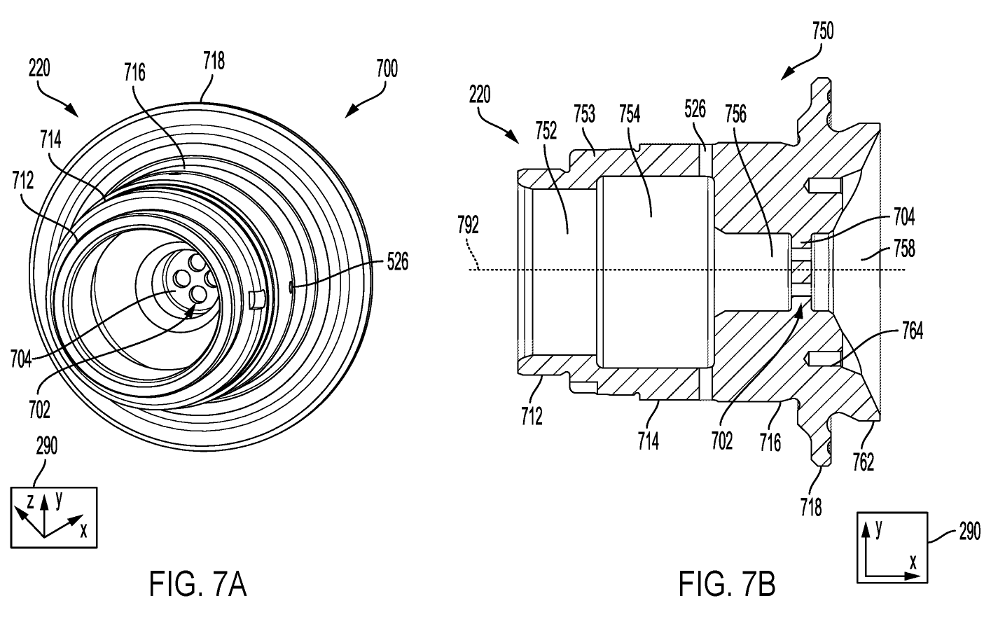

The following description relates to systems for a cooling arrangement for a drive unit. In one example, the drive unit is an electric motor of a vehicle, as illustrated in FIG. 1. FIG. 2 is a schematic depiction of a cross-section of a shaft of the electric motor. FIG. 3 is a depiction of a first side of an electric motor housing. FIG. 4 is a depiction of a second side of the electric motor housing. FIG. 5 is a depiction of a cross-sectional view of the motor shaft including a direction of lubricant flow. FIG. 6A is a first view of the shaft insert. FIG. 6B is a second view of the shaft insert. FIG. 6C is a cross-sectional view of the shaft insert. FIG. 7A is a perspective view of the shaft inlet flange. FIG. 7B is a cross-sectional view of the shaft inlet flange, according to an embodiment of the present disclosure.

FIGS. 1-7B show example configurations with relative positioning of the various components of the present disclosure. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation). FIGS. 2-7B are shown approximately to scale, however, other dimensions may be used if desired.

Turning now to FIG. 1, a vehicle 100 is shown comprising a powertrain 101 and a drivetrain 103. The powertrain comprises a prime mover 106 and a transmission 108. The prime mover 106 may be an internal combustion engine or an electric motor, for example, and is operated to provide rotary power to the transmission 108. The transmission 108 may be any type of transmission, such as a manual transmission, an automatic transmission, or a continuously variable transmission. The transmission 108 receives the rotary power produced by the prime mover 106 as an input and outputs rotary power to the drivetrain 103 in accordance with a selected gear or setting.

The prime mover 106 may be powered via energy from an energy storage device 105. In one example, the energy storage device 105 is a battery configured to store electrical energy. An inverter 107 may be arranged between the energy storage device 105 and the prime mover 106 and configured to adjust direct current (DC) to alternating current (AC). The prime mover 106 may include a variety of components and circuitry with thermal demands that effect an efficiency of the motor. As will be described herein, the prime mover 106 may include a cooling arrangement configured to meet the thermal demands of the components of the prime mover 106 while decreasing a packaging size thereof. The cooling arrangement of the prime mover 106 is described in greater detail with respect to FIGS. 2-7B herein.

The vehicle 100 may be a commercial vehicle, light, medium, or heavy-duty vehicle, a passenger vehicle, an off-highway vehicle, and sport utility vehicle. Additionally, or alternatively, the vehicle 100 and/or one or more of its components may be in industrial, locomotive, military, agricultural, and aerospace applications. In one example, the vehicle 100 is an electric vehicle and prime mover 106 is an electric motor.

In some examples, such as shown in FIG. 1, the drivetrain 103 includes a first axle assembly 102 and a second axle assembly 112. The first axle assembly 102 may be configured to drive a first set of wheels 104, and the second axle assembly 112 may be configured to drive a second set of wheels 114. In one example, the first axle assembly 102 is arranged near a front of the vehicle 100 and thereby comprises a front axle, and the second axle assembly 112 is arranged near a rear of the vehicle 100 and thereby comprises a rear axle. The drivetrain 103 is shown in a four-wheel drive configuration, although other configurations are possible. For example, the drivetrain 103 may include a front-wheel drive, a rear-wheel drive, or an all-wheel drive configuration. Further, the drivetrain 103 may include one or more tandem axle assemblies. As such, the drivetrain 103 may have other configurations without departing from the scope of this disclosure, and the configuration shown in FIG. 1 is provided for illustration, not limitation. Further, the vehicle 100 may include additional wheels that are not coupled to the drivetrain 103.

In some four-wheel drive configurations, such as shown in FIG. 1, the drivetrain 103 includes a transfer case 110 configured to receive rotary power output by the transmission 108. A first driveshaft 113 is drivingly coupled to a first output 111 of the transfer case 110, while a second driveshaft 122 is drivingly coupled to a second output 121 of the transfer case 110. The first driveshaft 113 (e.g., a front driveshaft) transmits rotary power from the transfer case 110 to a first differential 116 of the first axle assembly 102 to drive the first set of wheels 104, while the second driveshaft 122 (e.g., a rear driveshaft) transmits the rotary power from the transfer case 110 to a second differential 126 of the second axle assembly 112 to drive the second set of wheels 114. For example, the first differential 116 is drivingly coupled to a first set of axle shafts 118 coupled to the first set of wheels 104, and the second differential 126 is drivingly coupled to a second set of axle shafts 128 coupled to the second set of wheels 114. It may be appreciated that each of the first set of axle shafts 118 and the second set of axle shafts 128 may be positioned in a housing.

In some examples, additionally or alternatively, the vehicle 100 may be a hybrid vehicle including both an engine an electric machine each configured to supply power to one or more of the first axle assembly 102 and the second axle assembly 112. For example, one or both of the first axle assembly 102 and the second axle assembly 112 may be driven via power originating from the engine in a first operating mode where the electric machine is not operated to provide power (e.g., an engine-only mode), via power originating from the electric machine in a second operating mode where the engine is not operated to provide power (e.g., an electric-only mode), and via power originating from both the engine and the electric machine in a third operating mode (e.g., an electric assist mode). As another example, one or both of the first axle assembly 102 and the second axle assembly 112 may be an electric axle assembly configured to be driven by an integrated electric machine.

Turning now to FIGS. 2 and 5, they show an embodiment of a motor assembly 200. The motor assembly 200 may include a stator 260 and a rotor 270. Thus, in one example, the motor assembly 200 is an electric motor assembly 200. The stator 260 may include end windings 262 arranged at opposite ends thereof. The rotor 270 may include rotor end caps 272 that interface with a portion of a rotor shaft assembly 202. The rotor 270 may be positioned radially outside of the rotor shaft assembly 202.

An axis system 290 is shown including an x-axis parallel to an axial direction and a y-axis parallel to a vertical direction. A radial direction is parallel to a plane including the y-axis and a third axis normal (e.g., a z-axis shown in FIGS. 3-4 and 6A-6B) to the x- and y-axes. The motor assembly 200 may include a first side 292 and a second side 294. The second side 294 may be opposite the first side 292. In one example, the first side 292 is an inlet side and the second side 294 is an output side of the motor assembly 200, wherein power from the motor assembly 200 is transferred to a transmission, gearbox, wheel, or other device at the second side 294.

The rotor shaft assembly 202 may include three main parts including a shaft outlet flange 210, a shaft inlet flange 220, and a flow insert 230. In one example, the shaft outlet flange 210 and the flow insert 230 may define a shaft main body. The shaft main body may rotate about an axis of rotation parallel to the x-axis based on an operation of the rotor 270. In one example, the shaft main body rotates its central axis that is parallel to the x-axis. The flow insert 230 may be arranged in a cavity within the shaft outlet flange 210, wherein the cavity may be sealed via the shaft inlet flange 220. FIG. 2 shows a more detailed view of the motor assembly 200 relative to the view shown in FIG. 5.

The shaft outlet flange 210 is a moveable component. The flow insert 230, interchangeably referred to herein as insert 230, may be held within the cavity of the shaft outlet flange 210. The shaft outlet flange 210, the shaft inlet flange 220, the insert 230, and the rotor 270 may be rotating parts of the embodiment of FIGS. 5 and 2. In one example, the shaft inlet flange 220 and the shaft outlet flange 210 house the insert 230. The insert 230 is shown in greater detail with respect to FIGS. 6A, 6B, and 6C.

A shaft passage 512 may extend from the second side 294 to the first side 292. Fluid may flow from a lance 504, through the shaft inlet flange 220, radially around the insert 230 and/or directly through the insert 230, and into the shaft passage 512. The shaft passage 512 may be parallel to and aligned with the central axis of the shaft main body. In one example, the lance 504 is stationary and immovable.

The lance 504 may insert into a housing 252 of the electric motor 250 and into the shaft inlet flange 220. A seal 508 may be arranged at an interface between the lance 504 and the shaft inlet flange 220. The seal 508 may include a square cross-sectional shape. The seal 508 may be configured to allow a threshold amount of lubricant to flow to a first bearing 524 via an air vent 526 arranged in the shaft inlet flange 220. In one example, the air vent is free of a valve or other flow control device such that when lubricant flows past the seal 508 and into a chamber 528, the lubricant may freely flow through the air vent 526 toward the first bearing 524. In one example, the first bearing 524 is positioned to support the shaft inlet flange 220.

In one example, the lance 504 and the shaft inlet flange 220 are concentric, wherein the lance 504 is interior to (e.g., radially inward to) the shaft inlet flange 220. Together, the lance 504, the shaft inlet flange 220, and the insert 230 may promote a desired amount of lubricant flow and air flow through the shaft assembly 202.

Arrows indicate lubricant flow, air flow, and combinations thereof through the shaft assembly 202. Solid line, black head arrows indicate a flow of lubricant with air particles mixed therein. Black head arrows with dashed lines indicate a flow of lubricant free of air particles. White head arrows with dashed lines indicate a flow of air free of lubricant. Solid line, white head arrows indicate an air flow with lubricant particles mixed therein. A flow of lubricant with air particles mixed therein may include a greater amount of lubricant to air relative to a flow of air with lubricant particles mixed therein. In this way, four separate flow types are provided through the shaft assembly 202. Said another way, the flow of lubricant with air particles may be characterized in that a plurality of the flow comprises lubricant (e.g., more lubricant than air). The flow of air with lubricant particles may be characterized in that a plurality of the flow comprises air (e.g., more air than lubricant).

As illustrated, the lance 504 and the shaft inlet flange 220 may be shaped to reduce air flow through outer radial passages 510 of the insert 230. In one example, the lubricant flow with air mixed therein enters an axial passage 505 of the lance 504. Due to radial forces, oil may attach to an outer surface of radial grooves of the insert 230 and air may attach to inner surfaces of the radial grooves of the insert 230. Grooves of the insert 230 are shown in FIGS. 6A, 6B, and 6C. A portion of air may be released through the air vent 526 of the shaft inlet flange 220. The air vent 526 may be arranged in a center of rotation on the inner surface of the grooves where the air is collecting. Some amount of lubricant may leak through the seal, which may flow with the air to the bearing 524 via the air vent 526. Another portion of air trapped in radial passages of the insert 230 may be vented via axial channel 606. A further portion of air may flow from the chamber 528 back toward a housing cover 402.

The lance 504 may receive lubricant from a rear of the housing 252 of the motor and flow the lubricant to the shaft inlet flange 220. The axial passage 505 may extend through each of the lance 504 and the shaft inlet flange 220 to flow lubricant to the insert 230. The lubricant may flow to the plurality of radial passages between the insert 230 and the shaft outlet flange 210, which may guide the lubricant to the plurality of outer passages, thereby cooling a first portion of the shaft. The lubricant may exit the plurality of outer passages and enter a plurality of second radial passages at a second conical end of the insert 230, wherein the lubricant may flow to the shaft passage 512 of the first portion, aligned alone a shaft axis with the central passage of the static lance and rotating insert. In one example, the axial passage 505 is contiguous with the axial channel 606 and the shaft passage 512.

The shaft outlet flange 210 may be supported by the rotor 270 and second bearings 534. Second bearings 534 may be in face-sharing contact with a portion of the shaft outlet flange 210 downstream of the insert 230 relative to a direction of lubricant flow through the shaft outlet flange 210.

In an alternative embodiment, the shaft outlet flange 210 may include a radial passage 536. The radial passage 536 may be configured to divert lubricant from the shaft passage 512 to the second bearings 534. Additionally, or alternatively, the radial passage 536 may be configured to divert lubricant from the plurality of outer passages of the insert 230 to the second bearing 534.

Turning now to FIGS. 3 and 4, they show a first view 300 and a second view 400 of the housing 252, respectively. The first view 300 shows the second side 294 of the housing 252 and the second view 400 shows the first side 292 of the housing 252. In the first view 300, an oil port 302 receives lubricant from an oil pump 304 fluidly coupled to an oil sump 306. In one example, additionally or alternatively, the oil sump 306 is a gearbox. The first view 300 further illustrates the second bearings 534 upstream of splines 350 of the shaft outlet flange 210. The splines 350 may engage with a gear or other toothed element of the powertrain. The shaft passage 512 may output lubricant therein to an oil sump or a gearbox. The second view 400 shows a housing cover 402. The housing cover 402 may include shapes on an inner surface thereof that guide lubricant from interior passages of the housing 252 to the lance (e.g., lance 504 of FIG. 5).

Turning now to FIGS. 6A, 6B, and 6C, they show various views of the insert 230. View 600 illustrates a perspective view of an end of the insert 230 facing the first side (e.g., first side 292 of FIGS. 2 and 5) of the motor assembly. The insert 230 may include a plurality of inlet radial passages 602. The plurality of inlet radial passages 602 may be arranged on a first conical end 692 of conical ends of the insert 230. The plurality of inlet radial passages 602 may direct lubricant toward a plurality of outer axial passages 612. Each of the plurality of outer axial passages 612 may include a width greater than a width of each of the plurality of inlet radial passages 602. This may reduce lubricant turbulence as it flows axially between the insert 230 and the shaft outlet flange. Neighboring axial passages of the plurality of outer axial passages 612 may be separated via a plurality of axial protrusions 614. That is to say, lubricant in one of the plurality of outer axial passages 612 may not flow to any of the other outer axial passages. The plurality of axial protrusions 614 and the plurality of outer axial passages 612 may extend along an entire axial length of the insert 230.

The insert 230 may further include a collection opening 604, as shown in the third view 650 of FIG. 6C. The collection opening 604 may be configured to distribute lubricant to the plurality of inlet radial passages 602 and to an inner axial channel 606. More specifically, a plurality of first radial protrusions 608 shape each of the plurality of inlet radial passages 602 and the collection opening 604. The plurality of inlet radial passages 602 may increase in width in a radial outward direction away from the collection opening 604. An inner axial orifice 616 may fluidly couple the collection opening 604 to the inner axial channel 606. The inner axial orifice 616 may include a diameter smaller than a diameter of the inner axial channel 606. A shape of the first conical end 692 may be configured to promote lubricant flow to the plurality of outer axial passages 612 while allowing lubricant mixed with air to flow to the inner axial channel 606. In this way, churning losses due to air may be avoided and more efficient lubrication and cooling of the shaft may be achieved.

In one example, the inner axial orifice 616 is sized such that a restriction is present at the collection opening 604. The restriction may promote lubricant to flow to the plurality of inlet radial passages 602 while promoting air and lubricant to enter the inner axial channel 606.

FIG. 6B includes a second view 625 showing a second conical end 694 of the conical ends of the insert 230, which includes a plurality of outlet radial passages 622 and an inner axial channel outlet 632. The plurality of outlet radial passages 622 may be shaped via a plurality of second radial protrusions 624. The plurality of second radial protrusions 624 may terminate at a central protrusion 626 at which the inner axial channel outlet 632 is located. In one example, a slope of the plurality of outlet radial passages 622 may be different than a slope of the plurality of inlet radial passages 602. Each of the plurality of outlet radial passages 622 and the plurality of inlet radial passages 602 may be coupled to only one of the plurality of outer axial passages 612.

As illustrated in FIG. 6C, the first conical end 692 includes a first slope and the second conical end 694 includes a second slope. The first slope is different than the second slope.

Turning now to FIG. 7A, it shows a perspective view 700 of the shaft inlet flange 220. The shaft inlet flange 220 may include a first body 712, a second body 714, a third body 716, and a fourth body 718. In one example, the shaft inlet flange 220 is a single piece. The first body 712 may include a cylindrical shape having a first diameter. The second body 714 may include a cylindrical shape having a second diameter, the second diameter greater than the first diameter. The air vent 526 may be arranged in the second body 714. In one example, the air vent 526 is arranged at a location where the second body 714 transitions to the third body 716. The third body 716 may include a cylindrical shape having a third diameter, the third diameter greater than the first diameter and the second diameter. The fourth body 718 may include a disc shape having a fourth diameter, the fourth diameter greater than each of the third, second, and first diameters. In one example, the fourth body 718 may interface with the rotor end cap 272. In one example, the rotor end cap 272 may retain the shaft inlet flange 220 in a desired position via applying forces to the fourth body 718.

FIG. 7B shows a cross-sectional view 750 of the shaft inlet flange 220. The cross-sectional view 750 shows a first interior volume 752, a second interior volume 754, a third interior volume 756, and a fourth interior volume 758. The first interior volume 752 may include a first diameter shaped via the first body 712. The cross-sectional view 750 illustrates a stepped transition 753 from the first body 712 to the second body 714. The stepped transition 753 may include a 90-degree angle and extends from the first body 712 to the second body 714. The second interior volume 754 may include a second diameter shaped via the second body 714, wherein the second diameter of the second interior volume is greater than the first diameter of the first interior volume 752. The third interior volume 756 may include a third diameter shaped via the third body 716, wherein the third diameter of the third interior volume 756 is smaller than each of the first diameter of the first interior volume 752 and the second diameter of the second interior volume 754. The air vent 526 is arranged on an inner face of the second body 714 at a location corresponding to a center of rotation of the shaft inlet flange 220. In one example, the third interior volume 756 is sized to receive the lance (e.g., lance 504 of FIG. 5) such that the lance is in face-sharing contact with interior surfaces of the third interior volume 756. In this way, the seal (e.g., seal 508) may be compressed between interior surfaces of the third interior volume 756 and exterior surfaces of the lance. The first body 712 and the second body 714 may be sized to be spaced away from exterior surface of the lance as the lance extends through the first interior volume 752 and the second interior volume 754 toward the third interior volume 756. In one example, the chamber (e.g., chamber 528 of FIG. 5 may be arranged between the lance and the second body 714.

A barrier 704 is arranged between the third interior volume 756 and the fourth interior volume 758. The barrier 704 may include a plurality of perforations 702 that are misaligned with a central axis 792 of the shaft inlet flange 220. In one example, the plurality of perforations 702 is misaligned with a central axis of the shaft (e.g., rotor shaft assembly 202). The plurality of perforations 702 may divide the lubricant toward the collection opening 604 of FIG. 6C. The axial channel may vent air trapped in the plurality of inlet radial channels. By doing this, air may collect on surfaces of the shaft inlet flange 220, thereby releasing more air to the bearing (e.g., first bearing 524 of FIG. 5) and less to the shaft outlet flange (e.g., shaft outlet flange 210 of FIG. 5).

The fourth interior volume 758 may include a non-uniform diameter increasing from the barrier 704 toward the shaft outlet flange. In one example, the fourth interior volume 758 may include a conical shape shaped via a fifth body 762 that aligns with the first conical end 692 of the insert 230 of FIG. 6A. The first conical end 692 and the fifth body 762 may shape the plurality of inlet radial channels 602 of FIG. 6A. In one example, the fourth interior volume 758 includes a variable diameter that includes a smallest diameter equal to the third diameter of the third interior volume 756 and a largest diameter greater than the second diameter of the second interior volume 754. The fifth body 762 may include openings 764 configured to receive a coupling element, such as a locking pin, a bolt, or a screw. The openings 764 may be arranged between the barrier 704 and an outer surface of the fifth body 762.

The disclosure also provides support for a system including a shaft assembly comprising a shaft outlet flange, a shaft inlet flange, and an insert arranged in an interior volume shaped by the shaft outlet flange and the shaft inlet flange, wherein the shaft inlet flange comprises an interior volume with interior surfaces in face-sharing contact with a lance and radially aligned with a bearing, and an air vent arranged in the shaft inlet flange at a position upstream of the bearing and the interior volume relative to a direction of lubricant flow. In a first example of the system, the insert comprises conical ends comprising the plurality of radial passages, wherein the plurality of radial passages is fluidly coupled to a plurality of outer axial passages arranged on an outer diameter of the insert, between the conical ends, and wherein the center protrudes toward an inlet of the shaft assembly. In a second example of the system, optionally including the first example, a first conical end of the insert comprises a first slope and a second conical end comprises a second slope, the second slope different than the first slope. In a third example of the system, optionally including one or both of the first and second examples, the shaft assembly is an electric motor shaft assembly. In a fourth example of the system, optionally including one or more or each of the first through third examples, the insert comprises an axial passage that extends through an entire interior volume of the insert. In a fifth example of the system, optionally including one or more or each of the first through fourth examples, the shaft inlet flange comprises a barrier downstream of the interior volume, wherein the barrier comprises a plurality of perforations misaligned with a central axis of the shaft assembly. In a sixth example of the system, optionally including one or more or each of the first through fifth examples, the shaft inlet flange comprises a conical outlet configured to engage with the shaft outlet flange. In a seventh example of the system, optionally including one or more or each of the first through sixth examples, the insert comprises a plurality of protrusions that shape a plurality of passages on outer surfaces of the insert.

The disclosure also provides support for a system including an electric motor comprising a housing, a stator arranged in the housing and surrounding a rotor, a shaft arranged in the housing and at least partially surrounded by the rotor, wherein the shaft comprises a shaft inlet flange and a shaft outlet flange housing an insert, wherein the shaft inlet flange comprises an interior volume radially aligned with a bearing and having surfaces that receive a lance, the shaft inlet flange further comprises an air vent upstream of the interior volume relative to a direction of lubricant flow through the shaft inlet flange, and a shaft end cap pressed against an outer flange of the shaft inlet flange. In a first example of the system, exterior surfaces of the lance are pressed against interior surfaces of the interior volume of the shaft inlet flange. In a second example of the system, optionally including the first example, the shaft inlet flange comprises a barrier downstream of the interior volume, wherein the barrier comprises a plurality of perforations misaligned with a central axis of the shaft assembly. In a third example of the system, optionally including one or both of the first and second examples, an axial passage of the insert is aligned with the central axis of shaft assembly and configured to vent air trapped in radial channels of the insert. In a fourth example of the system, optionally including one or more or each of the first through third examples, the shaft inlet flange comprises an outer flange in contact with a rotor end cap. In a fifth example of the system, optionally including one or more or each of the first through fourth examples, the insert comprises radial and axial protrusions. In a sixth example of the system, optionally including one or more or each of the first through fifth examples, the air vent is parallel to a radial direction.

The disclosure also provides support for an electric motor assembly including a stator, a rotor, a shaft assembly comprising a shaft inlet flange and a shaft outlet flange, wherein the shaft assembly is configured to rotate about a central axis, an insert arranged in a cavity of the shaft outlet flange, the insert in face-sharing contact with each of the shaft inlet flange and the shaft outlet flange, and a lance that inserts into an interior volume of the shaft inlet flange, wherein an interface between the lance and the shaft inlet flange is configured to allow air to flow therethrough toward an air vent arranged in the shaft inlet flange. In a first example of the system, a distance between the air vent and the insert is greater than a distance between the interface and the insert. In a second example of the system, optionally including the first example, the air vent directs air to a bearing configured to support the shaft inlet flange. In a third example of the system, optionally including one or both of the first and second examples, the shaft inlet flange comprises a barrier with a plurality of perforations arranged between the insert and the lance. In a fourth example of the system, optionally including one or more or each of the first through third examples, the insert comprises a collection opening coupled a plurality of inlet radial passages and an inner axial opening, wherein the inner axial opening is configured to flow air to an axial passage of the insert, and wherein the plurality of inlet radial passages is configured to flow lubricant to a plurality of outer axial channels arranged between the insert and the shaft outlet flange.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system, comprising:
a shaft assembly comprising a shaft outlet flange, a shaft inlet flange, and an insert arranged in an interior volume shaped by the shaft outlet flange and the shaft inlet flange, wherein the shaft inlet flange comprises an interior volume with interior surfaces in face-sharing contact with a lance, the shaft inlet flange is and radially supported by a bearing; and
an air vent arranged in the shaft inlet flange at a position upstream of the bearing and the interior volume relative to a direction of lubricant flow.

2. The system of claim 1, wherein the insert comprises conical ends comprising a plurality of radial passages, wherein the plurality of radial passages is fluidly coupled to a plurality of outer axial passages arranged on an outer diameter of the insert extending between the conical ends, and wherein the plurality of outer axial passages face an interior surface of the shaft outlet flange.

3. The system of claim 2, wherein a first conical end of the conical ends comprises a first slope and a second conical end of the conical ends comprises a second slope, the second slope different than the first slope.

4. The system of claim 1, wherein the shaft assembly is an electric motor shaft assembly.

5. The system of claim 1, wherein the insert comprises an axial channel that extends through an entire interior volume of the insert.

6. The system of claim 1, wherein the shaft inlet flange comprises a barrier downstream of the interior volume, wherein the barrier comprises a plurality of perforations misaligned with a central axis of the shaft assembly.

7. The system of claim 1, wherein the shaft inlet flange comprises a conical outlet configured to engage with the shaft outlet flange.

8. The system of claim 1, wherein the insert comprises a plurality of protrusions that shape a plurality of passages on outer surfaces of the insert, and wherein the plurality of protrusions fluidly separate neighboring passages of the plurality of passages.

9. A system, comprising:
an electric motor comprising a housing;
a stator arranged in the housing and surrounding a rotor;
a shaft arranged in the housing and at least partially surrounded by the rotor, wherein the shaft comprises a shaft inlet flange and a shaft outlet flange housing an insert, wherein the shaft inlet flange comprises an interior volume radially aligned with a bearing and comprising surfaces that receive a lance in the interior volume, the shaft inlet flange further comprises an air vent, wherein the air vent is further from the insert than an interface between the lance and the shaft inlet flange ; and
a rotor end cap pressed against an outer flange of the shaft inlet flange.

10. The system of claim 9, wherein exterior surfaces of the lance are pressed against interior surfaces of the interior volume of the shaft inlet flange at the interface, further comprising a chamber arranged in the interior volume of the shaft inlet flange between the lance and the air vent.

11. The system of claim 9, wherein the shaft inlet flange comprises a barrier downstream of the interior volume, wherein the barrier comprises a plurality of perforations misaligned with a central axis of the shaft assembly.

12. The system of claim 9, wherein an axial channel of the insert is aligned with the central axis of shaft assembly and configured to vent air trapped in radial channels of the insert.

13. The system of claim 9, wherein a seal is arranged at the interface between the lance and the shaft inlet flange, and wherein the seal is configured to flow a greater amount of air toward the air vent than lubricant.

14. The system of claim 9, wherein the insert comprises radial and axial protrusions.

15. The system of claim 9, wherein the air vent is parallel to a radial direction.

16. An electric motor assembly, comprising:
a stator;
a rotor;
a shaft assembly comprising a shaft inlet flange and a shaft outlet flange, wherein the shaft assembly is configured to rotate about a central axis;
an insert arranged in a cavity of the shaft outlet flange, the insert in face-sharing contact with each of the shaft inlet flange and the shaft outlet flange; and
a lance that inserts into an interior volume of the shaft inlet flange, wherein an interface between the lance and the shaft inlet flange is configured to allow air to flow therethrough toward an air vent arranged in the shaft inlet flange.

17. The electric motor assembly of claim 16, wherein a distance between the air vent and the insert is greater than a distance between the interface and the insert.

18. The electric motor assembly of claim 16, wherein the air vent directs air to a bearing configured to support the shaft inlet flange.

19. The electric motor assembly of claim 16, wherein the shaft inlet flange comprises a barrier with a plurality of perforations arranged between the insert and the lance.

20. The electric motor assembly of claim 16, wherein the insert comprises a collection opening coupled a plurality of inlet radial passages and an inner axial orifice, wherein the inner axial orifice is configured to flow air to an axial channel of the insert, and wherein the plurality of inlet radial passages is configured to flow lubricant to a plurality of outer axial passages arranged between the insert and the shaft outlet flange.
